(19) United States
(12) Patent Application Publication
(10) Pub. No.: US 2011/0060718 A1
(43) Pub. Date: Mar. 10, 2011

(54) Method and Apparatus for Organizing Hierarchical Data in a Relational Database

(76) Inventors: Song You, Shanghai (CN); Wei Nie, Shanghai (CN); Yong Tian, Shanghai (CN)

(21) Appl. No.: 12/554,263

(22) Filed: Sep. 4, 2009

(51) Int. Cl. G06F 17/30

(52) U.S. Cl. 707/600; 707/E17.045

(57) ABSTRACT

A relational database is provided with a plurality of data entries stored in the database. The data entries have a hierarchical relationship. The data entries are assigned a real number, unique identifier, which can be calculated using a convergent series, capable of locating each data entry in the hierarchical structure. Each data entry is assigned a float type, level value, identifying the data entries hierarchical level in the structure. The data entries are also assigned an family value defining a hierarchical relationship with another data entry. The invented method allows for retrieving a sub-tree of any data entry by comparing two real numbers, and adding new data entries or a sub-tree without making changes to other data entries.

### FIELD OF THE INVENTION

The present invention relates generally to data organization system, components, and methods. More particularly, the present invention relates to data organization system, components, and methods that are configured to organize hierarchical data in a relational database.

### BACKGROUND OF THE INVENTION

The problem of choosing between a hierarchical database and a relational database comprises a fundamental problem in the art of database management and construction. A hierarchical database works well to organize data where each data element in the database is placed in a strict hierarchical relationship to some other element. Hierarchical databases, however, suffer from some major drawbacks. Foremost, is the fact that they lack the ability to easily manage any relationship between the elements of the database other than the hierarchical relationship and do not work well to manage complex relationships between database elements.

As an alternative, relational database products exist that work well in managing complicated associations between information and data. Relational databases offer many benefits for software developers and database administrators, including a standard query language (SQL) and transaction processing suitable for mission-critical applications; however, relational databases do not easily adapt to storing hierarchical data. Accordingly, database managers and developers are often faced with selecting between a relational or hierarchical database, especially in consideration of the fact that many types of data require hierarchical and relational management.

Several previous methods or devices provide for cooperative development of hierarchical and relational data management. However, the previous methods or devices involve increased complexity, extensive programming, increased computational overhead, and lack of growth flexibility.

Accordingly, a need exists for an improved method of organizing hierarchical data stored in a relational database.

### SUMMARY OF THE INVENTION

At least in view of the above, it would be desirable to provide a method for organizing hierarchical data in a relational database wherein data entries are stored in a relational database and associated with further information defining the hierarchical relationships between data entries. It would further be desirable that such information allow for flexibility of growth and change in the hierarchy, and for efficient retrieval and manipulation of the data entries and hierarchy.

The foregoing needs are met, to a great extent, by certain embodiments of the present invention. According to one such embodiment of the present invention, a method for organizing hierarchical data in a relational database includes the step of storing the relational database on a memory, where the database has multiple data entries that are hierarchically related to each other, and the memory is in communication with a control device. A further step may be generating a unique identifier for a data entry, the unique identifier defines the data entry's hierarchical relationship with another data entry. The method also includes assigning the data entry with a family value which indicates the hierarchical relationship with another data entry, and assigning the data entry with a level value which indicates the hierarchical relationship within a hierarchy.

In accordance with another embodiment of the present invention, it would further be possible to provide an apparatus for organizing hierarchical data in a relational database having a memory that stores a database of hierarchical data and instructions for organizing the hierarchical data, the database having at least one table that stores a plurality of data entries and hierarchical data. The table may have multiple columns: a column that stores a unique identifier, a column that stores a family value, a column that stores a level value, and a column that stores a data entry. The table may also have a row that stores the unique identifier, family value, level value, and data entry. Further included may be a control device that is in communication with the memory and that interacts with the database to execute the instructions or request execution the instructions.

In accordance with yet another embodiment of the present invention, it would further be possible to provide a system for organizing hierarchical data in a relational database having a means to store a plurality of data entries in a relational manner, and a means to organize the data entries in a hierarchical manner. Also included may be a means to generate a unique identifier for each data entry, where the unique identifier defines the data entry's hierarchical relationship with at least one other data entry. A means to assign each data entry with a family value, which indicates the hierarchical relationship with at least one other data entry, and a level value, which indicates the hierarchical relationship within at least one hierarchy may also be part of the system. Other means may include a means to store methods that organize the hierarchical data, and a means to request executing instructions.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic view of a system for organizing hierarchical data in a relational database according to an embodiment of the present invention.

FIG. 2A is a schematic view of the organization of data entries in a table of a relational database of the system for organizing hierarchical data according to an embodiment of the present invention.

FIG. 2B is a tree diagram of the data of FIG. 2A.

FIG. 3 is a flow diagram of an instruction to manipulate and organize the database for generating unique identifiers according to an embodiment of the present invention.

FIG. 4 is a flow diagram of instructions to manipulate and organize the database for retrieving sub-hierarchies according to an embodiment of the present invention.

FIG. 5 is a flow diagram of instructions to manipulate and organize the database for deleting sub-hierarchies according to an embodiment of the present invention.

FIG. 6 is a flow diagram of instructions to manipulate and organize the database for reassign data entries with new unique identifiers to achieve geometric series according to an embodiment of the present invention.

### DETAILED DESCRIPTION

An embodiment of the present inventive method and system for organizing hierarchical data in a relational database through the use of a convergent series can provide a memory to store the database, a set of instructions to manipulate and organize the database, and a control device to interact with the database.

The memory may provide a storage function for the database, including the structural and organizational elements of the database, and the data entries which populate the database. Other embodiments may have the memory provide a storage function for the instructions to manipulate and organize the database. The memory may exist, for example, as a separate entity, as part of a database server, or as part of a control device.

In addition to the memory, the method and system may provide a set of instructions to manipulate and organize the database. These instructions may reside on the memory whether or not the memory exists separate from the control device. Alternatively, the instructions may reside on a second memory which may be a part of the control device. The instructions may provide a wide array of functions for manipulating and organizing the database. Such functions may include, for example: generating a unique identifier for each data entry, assigning each data entry with a family value, assigning each data entry with a level value, reassigning data entries with unique identifiers after being moved, reassigning data entries with unique identifiers to achieve geometric series in a hierarchy, retrieving a sub-hierarchy of any data entry, deleting a sub-hierarchy of any data entry, creating an organizational table, extracting the data entries to a data file.

The method and system may further provide a control device to control device to interact with the database. Such device may be in communication with the memory. The control device may be used to make requests to run the instructions to manipulate and organize the database, for example, when the instructions reside on the memory, for example, as part of a database server. Another embodiment may have the control device executing the instructions, for example, when the instructions reside on a second memory in the control device and the memory containing the database is separate from the control device, or when the instructions and database reside on the memory as part of the control device.

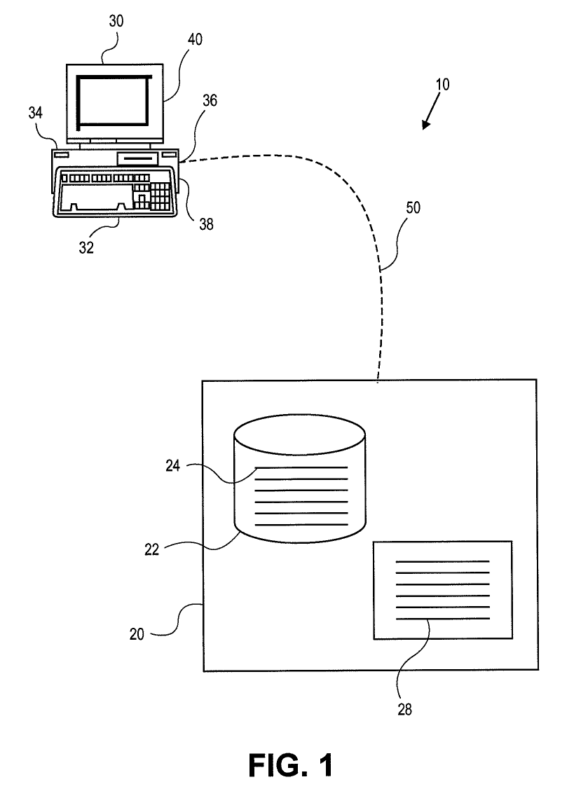

The invention will now be described with reference to the drawing figures, in which like reference numerals refer to like parts throughout. FIG. 1 is a schematic diagram illustrating a system for organizing hierarchical data in a relational database (“organizing system”) 10 according to an embodiment of the present invention. The organizing system 10 may include a memory 20. The memory 20 may further include a relational database 22 containing multiple data entries 24. The data entries 24 may have a hierarchical relationship to each other. In some embodiments the memory 20 containing the database 22 may be part of a database server.

In another embodiment, the memory 20 may also contain instructions to manipulate and organize the database 28. The instructions 28 are discussed in greater detail below.

The organizing system may also include a control device 30. The control device 30 may include an input device 32, a second memory 34, a communication device 36, a processor 38, and a display 40, all of which can be interconnected by a data link. The control device 30 can be a general computer, such as a personal computer (PC), a UNIX workstation, a server, a mainframe computer, a personal digital assistant (PDA), a cellular phone, a smartphone, or some combination of these. Alternatively, the control device 30 can be a specialized computing device, such as a vehicle diagnostic scan tool. The remaining components can include programming code, such as source code, object code or executable code, stored on a computer-readable medium that can be loaded into the memory 34 and processed by the processor 38 in order to perform the desired functions of the organizing system 10.

In various embodiments, the control device 30, and the memory 20 can be coupled to a communication network 50, which can include any viable combination of devices and systems capable of linking computer-based systems, such as the Internet; an intranet or extranet; a local area network (LAN); a wide area network (WAN); a direct cable connection; a private network; a public network; an Ethernet-based system; a token ring; a value-added network; a telephony-based system, including, for example, T1 or E1 devices; an Asynchronous Transfer Mode (ATM) network; a wired system; a wireless system; an optical system; a combination of any number of distributed processing networks or systems or the like. The communication network 50 allows for communication between the control device 30 and the memory 20.

The control device 30 can be coupled to the communication network 50 by way of the communication device 36, which in various embodiments can incorporate any combination of devices—as well as any associated software or firmware—configured to couple processor-based systems. Such communications devices 36 may include modems, network interface cards, serial buses, parallel buses, LAN or WAN interfaces, wired, wireless or optical interfaces, and the like, along with any associated transmission protocols, as may be desired or required by the design.

Additionally, an embodiment of the organizing system 10 can communicate information to the user through the display 40 and request user input through the input device 32 by way of an interactive, menu-driven, visual display-based user interface, or graphical user interface (GUI). The user interface can be executed, for example, on a personal computer (PC) with a mouse and keyboard, with which the user may interactively input information using direct manipulation of the GUI. Direct manipulation can include the use of a pointing device, such as a mouse or a stylus, to select from a variety of selectable fields, including selectable menus, drop-down menus, tabs, buttons, bullets, checkboxes, text boxes, and the like. Nevertheless, various embodiments of the invention may incorporate any number of additional functional user interface schemes in place of this interface scheme, with or without the use of a mouse or buttons or keys, including for example, a trackball, a touch screen or a voice-activated system.

Additional embodiments may have the instructions to manipulate and organize the database 28 reside on the second memory 34 of the control device 30 while the relational database 22 resides on the memory 20. The instructions 28 may also reside on the memory 20 while the relational database 22 may reside on the second memory 34. It is also conceived that the memory 20 is part of the control device 30. Further still, the database server may exist as part of the control device 30.

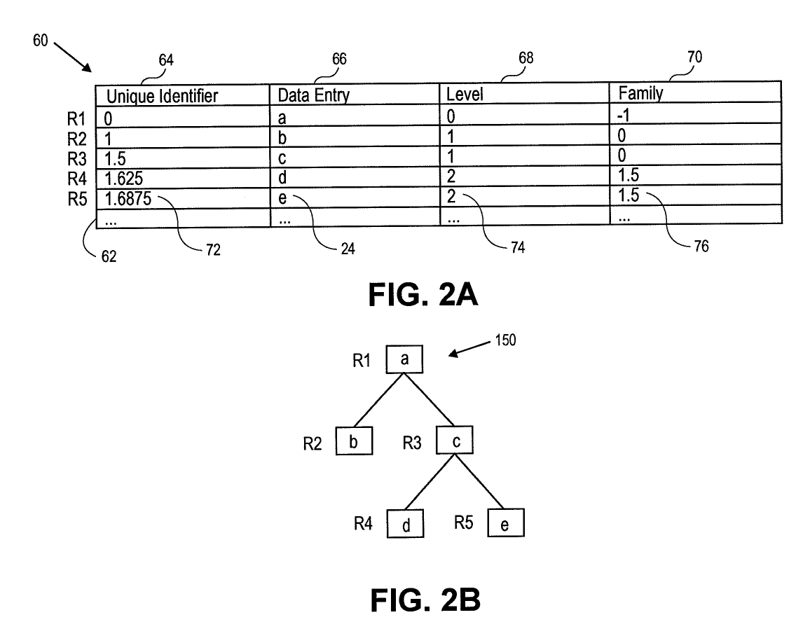

Referring now to FIG. 2A, the relational database 22 organizes the data entries 24 in at least one table 60. The table 60 contains a row 62 corresponding with each data entry 24. In an embodiment of the present invention, the table 60 further contains at least one unique identifier column 64, at least one data entry column 66, at least one level column 68, and at least one family column 70.

The at least one unique identifier column 64 contains a unique identifier 72 for each data entry 24. In one embodiment of the present invention, the unique identifier 72 is a real number. Further, the unique identifier 72 may be of the float data-type. The unique identifier 72 is assigned to each data entry by a unique identifier method that calculates each unique identifier 72 by way of a convergent series, which is described in further detail below. For one embodiment, with exception of the topmost data entry 24 in the hierarchy, each data entry 24 may have a unique identifier 72 with a value greater than zero. The unique identifier 72 defines a data entry's 24 position in a hierarchical structure relative to the other data entries 24, which is also described in further detail below.

The data entry column 66 contains the plurality of data entries 24. It should be understood by one skilled in the art that the data entries 24 may contain information such that a single column could be used to store and organize the information, or that the information in the data entries 24 may require multiple columns to properly store and organize the information. In either instance it is important to realize that no matter the number of columns used to contain a data entry 24, the unique identifier 72 assigned to the data entry is applicable to all the columns in the row 62 associated with a data entry 24. The data entry columns 66 are not limited in the type of information that they can store.

The at least one level column 68 is configured to store a level value 74 indicating at which level in a hierarchy a data entry 24 is located. By way of example, a hierarchy may take the form of a tree, where each data entry 24 has a relationship to another data entry 24 represented by a branch of that tree. The tree has a certain number of levels with data entries 24 located at each level. Each branch of the tree terminates at a data entry 24 located at a certain level. In one embodiment of the present invention, the level value 74 may be of the integer data-type. In such an embodiment, the topmost level value 74 is typically zero.

The at least one family column 70 is configured to store a family value 76 indicating a relationship between one data entry 24 and another data entry 24 located on a level either above or below. In an embodiment of the present invention, the family value 76 for a data entry 24 is the unique identifier 72 of its parent data entry 24, or the data entry 24 located at a higher level with which it has a direct relationship. In such a case, the family value 76 could be a real number of the float data-type. Further, the topmost data entry 24 in a hierarchy would not have a parent data entry 24, thus the family value 76 should be assigned to a value that will not be used as a unique identifier 72 for any other data entry 24. For example, the topmost data entry's 24 family value 76 is −1.

Again referring to FIG. 2A, the rows 62 have been labeled R1-R5 for the purpose of the following explanation of the embodiment depicted in the figure. As one may see the level value 74 for R1 is 0, and the family value 76 for R1 is −1, both of which indicate that the data entry 24 of R1 is the root entry of the hierarchy. Next, it may be observed that R2 and R3 have the same level values 74 and family values 76, and R4 and R5 have the same level values 74 and family values 76. This demonstrates that within the hierarchy of the data, the data entries 24 of R2 and R3 are on the same level of the hierarchy. It also demonstrates that the data entries 24 of R2 and R3 are both child entries of the data entry 24 of R1, since the family values 76 of R2 and R3 are equal to the unique identifier 72 of R1. Similarly, the data entries 24 of R4 and R5 are entries on the same level of the hierarchy as each other by virtue of their equal level values 74, but on a different level from R1-R3. Further, the data entries 24 of R4 and R5 are child entries of the data entry 24 of R3, because the family values 76 of R4 and R5 are equal to the unique identifier 72 of R3. Thus, the table 60 represents a hierarchy that may be depicted as a tree 150 in FIG. 2B, where the labels R1-R5 correspond to the labels R1-R5 of FIG. 2A

It should be appreciated by one skilled in the art, that implementation of the table 60 does not have to be limited to one hierarchy, and that data entries 24 may exist in multiple hierarchies. As such, it may be necessary to allow for multiple versions of each of the columns that identify a data entry's position and relationships in the hierarchies. Simple database queries could construct different hierarchies by accessing a different group of columns.

In one embodiment of the present invention, the memory 20 may contain multiple instructions to manipulate and organize the database 28, however the instructions 28 may reside on the second memory 34.

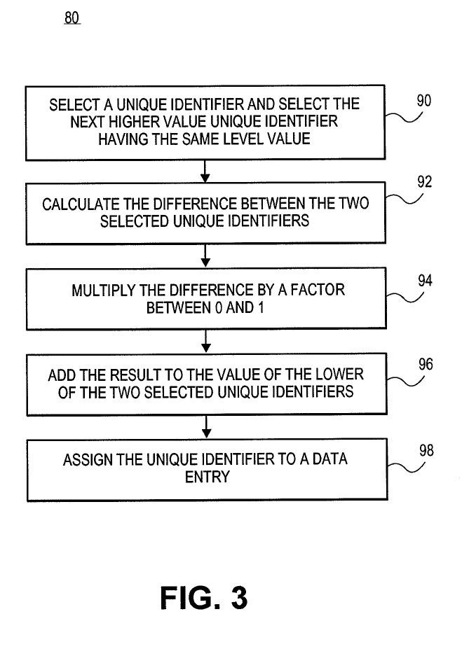

One such instruction 28 is the method for generating a unique identifier 80 depicted in FIG. 3. A unique identifier 72 may be generated for a data entry 24 when it is a new data entry 24 being inserted into the database 22. Generating a unique identifier 72 is accomplished by comparing the unique identifiers 72 of two neighboring data entries 24, between which a new data entry 24 is to be inserted, and selecting a new unique identifier 72 in between the values of the other two unique identifiers 72. In one embodiment of the present invention, this is accomplished by using one unique identifier 72, and using it as a reference to select from table 60 the next higher valued unique identifier 72 having the same level value 74 (step 90). Then calculating the difference in value between the greater and lesser unique identifiers 72 (step 92) and multiplying the difference by a factor between 0 and 1 (step 94), for example 0.5. The result added to the lesser unique identifier 72 (step 96) (or subtracted from the greater unique identifier 72) is the new unique identifier 72 assigned to the new data entry 24 (step 98) which is inserted into the hierarchy.

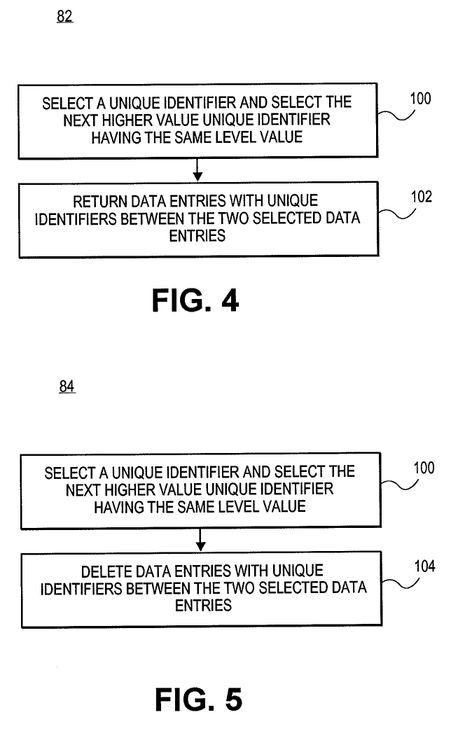

The method for generating a unique identifier 80 may be integrated into a method to reassign a unique identifier 72 for a data entry 24 moved in the hierarchy. However, the difference is that instead of a new data entry 24 being inserted into the hierarchy, here the data entry 24 is preexisting in the database 22 and the unique identifier 72 is calculated in the same way as above (step 100 in FIG. 4) for its new position between other data entries 24 in the hierarchy. Once the new unique identifier 72 is calculated, the data entry 24 to be moved is assigned with the unique identifier 72. Of course when repositioning a data entry, it may be required that the level value 74 and the family value 76 be reassigned accordingly.

The method for generating a unique identifier 80 may also be integrated as part of a method for reassigning the unique identifiers of a relocated sub-hierarchy of data entries. In one embodiment of the present invention, the topmost data entry 24 of the sub-hierarchy is assigned a new position in the hierarchy by, for example, reassigning its family value 76 and using the method for generating the unique identifier 80 in the same manner as it is used to reassign a unique identifier 72 for a data entry 24 moved in the hierarchy. Then repeat the process for each data entry 24 that is in the sub-hierarchy.

One advantage of the method for generating a unique identifier 80 is that because it places any new unique identifier 72 between already existing unique identifiers 72, there is no need to renumber any data entries 24 other than the new or moved ones. A feature of an embodiment of the current invention that aids in achieving this advantage is the use of the float data-type for the unique identifier 72. The float data-type has a broad range of values (for example, −1.79E+308 to −2.23E-308, 0 and 2.23E-308 to 1.79E+308) and accommodates very small fractional values, which is helpful when calculating a value between other values. This method and the float data-type further allow for a flexible hierarchy structure that can grow, without having to add columns to table 60 and thus increasing the complexity and computational cost of query statements. Using the float data-type is also advantageous in that is it computationally less expensive than using a string data-type which would require the use of expensive string parsing operations.

Referring now to FIG. 4, a method to retrieve a sub-hierarchy 82 may also be implemented. In one embodiment of the present invention the sub-hierarchy may be all the data entries 24 between a given topmost data entry 24 of the sub-hierarchy and the next data entry 24 with the same level value 74. The method could compare neighboring data entries 24 (i.e. a data entry 24 and the next data entry 24 with the same level value 74) (step 100). The method could return from the database 22 all data entries 24 with unique identifiers 72 between the values of the unique identifiers 72 of the topmost data entry 24 and the next data entry 24 (step 102). FIG. 5 depicts a similar method to delete a sub-hierarchy 84 that may also be implemented. The method is the same as the method to retrieve a sub-hierarchy 82, except it can delete the sub-hierarchy 82 from the database 22 all data entries 24 with unique identifiers 72 between the values of the unique identifiers 72 of the topmost data entry 24 and the next data entry 24 (step 104), instead of returning them.

The methods to retrieve a sub-hierarchy 82 and to delete a sub-hierarchy 84 illustrate another advantage of the present application. Because of the manner of assigning unique identifiers 72, the hierarchies are traversable without the need for running expensive recursive methods. The hierarchies can be traversed simply by comparing the values of the unique identifiers 72.

Use of this method for generating the unique identifier 80 and using the method to add new data entries to the hierarchy represents a convergent series. This is shown by the following (where NodeID is used to reference a unique identifier 72 and node is used to reference a data entry 24):
Suppose x₁, x₂, x₃, . . . , x₄ are NodeIDs of children nodes of the node x whose NodeID is x and x₁<x₂<x₃< . . . <xₙ. Note that the node x can be any node in a hierarchy.

parent_id(x₁)=parent_id(x₂)= . . . =parent_id(xₙ)=x <1>
The following are four definitions:

$$\begin{matrix}next\_node ( {x}_{n - 1} ) := {x}_{n} = {x}_{n - 1} + step\_br ( {x}_{n - 1} ) & 〈 2 〉 \\ \begin{matrix}step\_br ( {x}_{n} ) := {x}_{n + 1} - {x}_{n} = \frac{step\_ch ( parent\_id ( {x}_{n} ) )}{{2}^{n}} \\ = \frac{step\_ch ( x )}{{2}^{n}}\end{matrix} & 〈 3 〉 \\ \begin{matrix}step\_ch ( x ) := x - {x}_{1} = \frac{step\_br ( x )}{2} \\ = \frac{next\_node ( x ) - x}{2}\end{matrix} & 〈 4 〉 \\ step\_ch ( 0 ) := 1 & 〈 5 〉\end{matrix}$$

The definition of the function parent_id(x):

CREATE Function dbo.parent_id(@x float)
RETURN int
AS
BEGIN

DECLARE @parent_x int

SELECT @parent_x = ParentID FROM Tree
WHERE NodeID = @x
RETURN(@next_x)
END;

The definition of the function next_node(x):

CREATE Function dbo.next_node(@x float)
RETURN int
AS
BEGIN

DECLARE @next_x int

SELECT @next_x = TOP NodeID FROM Tree
WHERE NodeID > x AND Level = (SELECT Level FROM Tree

WHERE NodeID = @x)

ORDER BY NodeID ASC
RETURN(@next_x)
END;

First proving the validity of the algorithm of method to retrieve a sub-hierarchy.
From the aforementioned formula <4>, it is possible to get:

$${x}_{1} = x + step\_ch ( x ) \\ {x}_{2} = {x}_{1} + step\_br ( {x}_{1} ) = x + step\_ch ( x ) + \frac{step\_ch ( x )}{2} \\ \begin{matrix}{x}_{n} := {x}_{n - 1} + step\_br ( {x}_{n - 1} ) = x + step\_ch ( x ) + \frac{step\_ch ( x )}{2} + \\ \frac{step\_ch ( x )}{4} + … + \frac{step\_ch ( x )}{{2}^{n - 1}} \\ = x + step\_ch ( x ) \frac{1 - {0.5}^{n}}{1 - .05}\end{matrix} \qquad 〈 6 〉$$

The xₙ increases as n increase, and when n is large enough:

$$\begin{matrix}{lim}_{n \to ∞} {x}_{n} = {lim}_{n \to ∞} ( x + step\_ch ( x ) \frac{1 - {0.5}^{n}}{1 - 0.5} ) \\ = x + 2 step\_ch ( x ) \\ = x + step\_br ( x ) \\ = next\_node ( x )\end{matrix} \qquad 〈 7 〉$$

Resulting in:

xₙ<next_node(x)=next_node(parent_id(xₙ)) <8>
The inequality formula <8> tells that all NodeIDs of the sub-hierarchy of any given node x are less than the next node of x, which validates the algorithm of method to retrieve a sub-hierarchy.
From this is it possible to prove the validity of the algorithm of adding nodes or a sub-hierarchy by using the method for generating a unique identifier 80. Considering a sub-hierarchy consists of several nodes, if the validity of the algorithm of adding a node using the method for generating a unique identifier 80 is proved, it would be self-evident that the algorithm also applies to the scenario of adding a sub-hierarchy. To prove the validity of adding a single node, it is necessary to prove that formula <9> is still valid after new node is added. Suppose xₐ is the NodeID of any node of the hierarchy, x_{b}=next_node(xₐ) and x₁, x₂, x₃, . . . , x₄ are the NodeIDs of children nodes of node xₐ (x₁<x₂<x₃< . . . <xₙ). Based on formula <8>:

xₙ<next_node(xₐ)=x_{b}
Now adding a new node whose NodeID is between xₐ and x_{b}, and suppose the NodeID of the new node is xₐ. Following the method for generating a unique identifier 80, an adjusted value for xₐ is achieved. Suppose the adjusted value is called y, then:

$${x}_{a} < {x}_{n} < {x}_{b} \\ {x}_{n} \leq max\_id ( x ) \vert x < {x}_{b} . x ∈ \{ NodeID \} = y \\ {x}_{n} < \frac{{x}_{n} + {x}_{b}}{2} \leq \frac{y + {x}_{b}}{2} = {x}_{c} \qquad 〈 9 〉$$

The inequality formula <9> tells that xₙ<x_{c}=next_node(xₐ) i.e. the formula <8> is still valid after adding the new node x_{c}. Here it is proved that the adding algorithm using the method for generating a unique identifier 80 is valid.

It was noted above that a factor of 0.5 may be used to calculate the unique identifiers 72. That factor was again used in the above proof in formula <6>. However, it should be apparent to one skilled in the art that the factor could be any number between 0 and 1, allowing for varying rates of convergence. For example, a factor of 0.9 would provide for a slower convergence than when using a factor of 0.5, and would allow for a greater number of useable unique identifiers 72.

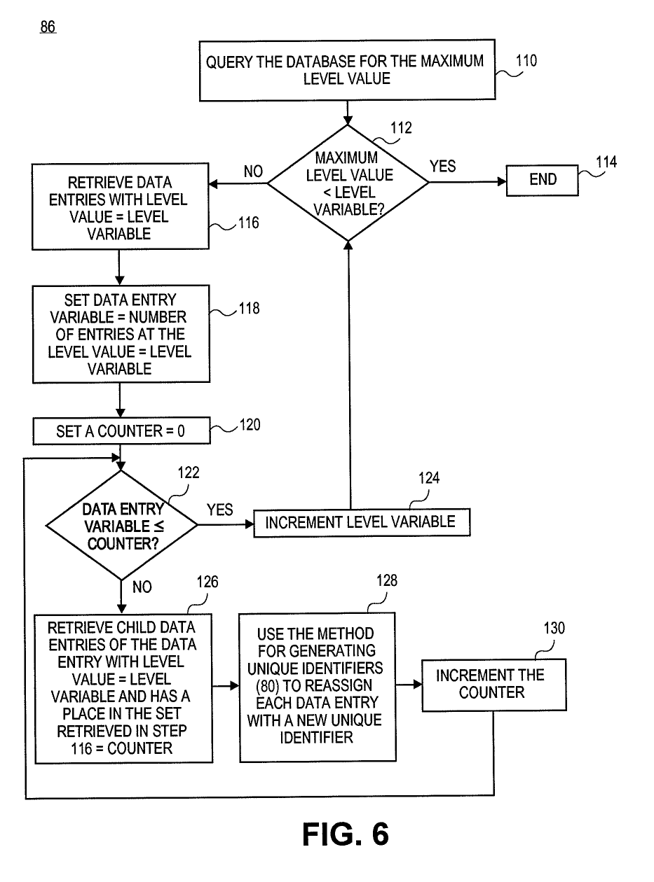

While there is no need to renumber data entries 24 in the hierarchy, other than when they are moved, it may be desirable to renumber the entire hierarchy to achieve a geometric series. The method for generating the unique identifier 80 may further be used to reassign the unique identifiers 72 for the entire hierarchy. In one embodiment of the present invention, a method to reassign data entries with new unique identifiers to achieve geometric series 86 consists of two loops, depicted in FIG. 6. First query the database 22 for the maximum level value 74 (step 110). Then enter the first loop and compare the level value to a level variable set to, for example, zero if the level value of the root node is −1 (step 112). If the maximum level value 74 is less than the level variable, end the method (step 114). Otherwise, retrieve all of the data entries 24, in ascending order, with a level value 74 equal to the level variable (step 116). Retrieve the number of data entries 24 at that level and set a data entry variable to that value (step 118). Set a counter to zero (step 120). Compare the data entry variable to the counter (step 122). If the data entry variable is less than or equal to the counter, then increment the level variable and return to the step 112 above where the maximum level value 74 is compared to the level variable (step 124). Otherwise, select the data entry 24, from the set of data entries 24 retrieved in step 116, which has a place in the set of data entries 24 corresponding to the counter value, and retrieve all of the child data entries 24 of that data entry 24 (step 126). Use the method for generating a unique identifier 80 to reassign the unique identifier 72 for each of the latest received data entries 24 (step 128). Increment the counter and return to return to step 122 above where the counter is compared to the data entry variable (step 130).

Yet another method of the present invention is a method to extract and convert data entries. The data entries may be converted to a data file readable by other applications. In an embodiment of the present invention, the data entries 24 retrieved may be ordered first by level value, then family value, then unique identifier. Then the ordered data entries 24 are extracted to a binary file. It may be desirable that a data record in the binary file contain the information from a data entry 24, the start address of the data entry 24 (converted from the unique identifier 72), the start address of the storage where the content of the data entry 24 is stored, the start address of the first child of the data entry 24 (converted from the family value 76), and the number of children of the current node (calculated from the number of data entries with the same family value 76).

FIGS. 1-7 are schematic diagrams and flowcharts of methods and systems according to various embodiments of the present invention. It will be understood that each step of the flowchart illustration, and combinations of steps in the flowchart illustration, can be implemented by computer program instructions or other means. Although computer program instructions are discussed, an apparatus according to the present invention can include other means, such as hardware or some combination of hardware and software, including one or more processors or controllers, for performing the disclosed functions.

In this regard, FIG. 1 depicts the system of one embodiment including several of the key components of a general-purpose computer by which an embodiment of the present invention may be implemented. Those of ordinary skill in the art will appreciate that a computer can include many more components than those shown in FIG. 1. However, it is not necessary that all of these generally conventional components be shown in order to disclose an illustrative embodiment for practicing the invention. The general-purpose computer can include a processing unit 38, and a system memory 34, which may include random access memory (RAM) and read-only memory (ROM). The computer also may include nonvolatile storage memory, such as a hard disk drive, where additional data can be stored.

An embodiment of the present invention can also include one or more input devices 32, such as a mouse, keyboard, and the like. A display 40 can be provided for viewing text and graphical data, as well as a user interface to allow a user to request specific operations. Furthermore, an embodiment of the present invention may be connected to one or more remote computers via a communication device 36. The connection may be over a communication network 50, such as a local area network (LAN) wide area network (WAN), and can include all of the necessary circuitry for such a connection.

Typically, computer program instructions, such as portions of the instructions for manipulating and organizing the database 28, may be loaded onto the computer or other general purpose programmable machine to produce a specialized machine, such that the instructions that execute on the computer or other programmable machine create means for implementing the functions specified in the flowchart. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the flowchart.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the flowchart steps.

Accordingly, steps of the flowchart support combinations of means for performing the specified functions, combinations of steps for performing the specified functions and program instruction means for performing the specified functions. It will also be understood that each step of the flowchart, as well as combinations of steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for organizing hierarchical data in a relational database, comprising the steps of:
storing on a memory the relational database having a plurality of data entries that are hierarchically related to each other, and the memory is in communication with a control device;
generating a unique identifier for a data entry, the unique identifier defining the data entry's hierarchical relationship with at least one other data entry;
assigning the data entry with a family value indicating the hierarchical relationship with at least one other data entry; and
assigning the data entry with a level value indicating the hierarchical relationship within at least one hierarchy.

2. The method of claim 1, wherein generating the unique identifier further comprises comparing the unique identifiers of neighboring data entries in the hierarchy and calculating a value in between the values of the neighboring data entries' unique identifiers.

3. The method of claim 2, wherein the value is a real number.

4. The method of claim 2 further comprising reassigning data entries with new unique identifiers after being moved in the hierarchy.

5. The method of claim 2 further comprising reassigning data entries with new unique identifiers to achieve geometric series in any hierarchy.

6. The method of claim 1 further comprising retrieving a sub-hierarchy of any data entry.

7. The method of claim 1 further comprising:
determining the unique identifiers of neighboring data entries in the hierarchy; and
returning the data entries having unique identifiers with values between the compared neighboring unique identifiers.

8. The method of claim 1 further comprising deleting a sub-hierarchy of any data entry.

9. The method of claim 1 further comprising:
determining the unique identifiers of neighboring data entries in the hierarchy; and
deleting the data entries having unique identifiers with values between the compared neighboring unique identifiers.

10. The method of claim 1, wherein providing a relational database further comprises creating an organizational table having a column storing the unique identifier, a column storing the family value, a column storing the level value, a column storing the data entry, and a row storing the unique identifier, family value, level value, and data entry.

11. The method of claim 10, wherein the unique identifier is a float data type.

12. The method of claim 1 further comprising extracting the data entries to a data file readable by other applications.

13. The method of claim 12, wherein extracting the data entries comprises ordering the data entries by level value, then family value, and then unique identifier.

14. The method of claim 13, wherein extracting the data entries further comprises converting the data entries to a binary file.

15. An apparatus for organizing hierarchical data in a relational database, comprising:
a memory that stores a database of hierarchical data and instructions for organizing the hierarchical data, the database having at least one table that stores a plurality of data entries and hierarchical data, the at least one table having a column that stores a unique identifier, a column that stores a family value, a column that stores a level value, a column that stores a data entry, and a row that stores the unique identifier, family value, level value, and data entry; and
a control device in communication with the memory that interacts with the database and one of executes the instructions and requests execution the instructions.

16. The apparatus of claim 15, further comprising the column that stores the unique identifier having a data type of float.

17. The apparatus of claim 15, wherein the memory further comprising an instruction for calculating the unique identifier for the data entry.

18. The apparatus of claim 15, wherein the memory further comprising an instruction for reassigning unique identifiers to moved data entries.

19. The apparatus of claim 15, wherein the memory further comprising an instruction for reassigning unique identifiers to all data entries.

20. The apparatus of claim 15, wherein the memory further comprising an instruction for retrieving a sub-hierarchy including the data entries having unique identifiers between neighboring data entries in the hierarchy.

21. The apparatus of claim 15, wherein the memory further comprising an instruction for deleting a sub-hierarchy including the data entries having unique identifiers between neighboring data entries in the hierarchy.

22. The apparatus of claim 15, wherein the memory further comprising an instruction for extracting the data entries to a data file configured to be readable by other software applications.

23. The apparatus of claim 15, wherein the memory further comprising an instruction for ordering the data entries by level value, then family value, then unique identifier.

24. The apparatus of claim 15, wherein the memory further comprising an instruction for converting the data entries to a binary file.

25. The apparatus of claim 15, wherein the memory exists as part of a database server.

26. A system for organizing hierarchical data in a relational database, comprising:
means for storing configured to store a plurality of data entries in a relational manner;
means for organizing configured to organize the data entries in a hierarchical manner;
means for generating configured to generate a unique identifier for each data entry provided, wherein the unique identifier is configured to define the data entry's hierarchical relationship with at least one other data entry;
means for assigning configured to assign each data entry with a family value indicating the hierarchical relationship with at least one other data entry and a level value indicating the hierarchical relationship within at least one hierarchy;
means for storing configured to store methods that organize the hierarchical data; and
means for requesting configured to request executing instructions.

27. The system of claim 26, further comprising means for reassigning configured to reassign unique identifiers to moved data entries.

28. The system of claim 26, further comprising means for reassigning configured to reassign unique identifiers to all data entries.

29. The system of claim 26, further comprising means for retrieving configured to retrieve a sub-hierarchy comprising the data entries having unique identifiers between neighboring data entries in the hierarchy.

30. The system of claim 26, further comprising means for deleting configured to delete a sub-hierarchy comprising the data entries having unique identifiers between neighboring data entries in the hierarchy.

31. The system of claim 26, further comprising means for extracting configured to extract the data entries to a data file configured to be readable by other software applications.

32. The system of claim 31, further comprising means for ordering configured to order the data entries by level value, then family value, then unique identifier.

33. The system of claim 32, further comprising means for converting configured to convert the data entries to a binary file.
